(19) United States
(12) Patent Application Publication
(10) Pub. No.: US 2011/0292506 A1
(43) Pub. Date: Dec. 1, 2011

(54) EYECUP FOR USE WITH NIGHT VISION GOGGLES AND OTHER OPTICAL DEVICES HAVING AN EYEPIECE

(75) Inventor: Lenard V. Ramboyong, South Riding, VA (US)

(73) Assignee: United States of America, as represented by the Secretary of the Army, Fort Belvoir, VA (US)

(21) Appl. No.: 12/791,120

(22) Filed: Jun. 1, 2010

(51) Int. Cl. G02B 23/18

(52) U.S. Cl. 359/507

(57) ABSTRACT

A vapor-permeable, vented eyecup for night vision goggles and other optical devices having an eyepiece. An eyecup is used to create a light tight seal between the eyepiece and the operator's face. In addition to containing the light from the optical device, the eyecup blocks out external light. When viewing through an optical device using a non-vented eyecup, moisture becomes trapped in the eyecup volume bounded by the operator's eye socket, eyecup, and eyepiece. Fog forms on the eyepiece as a result. This invention reduces the occurrence of fogging by allowing moisture to vent out of the volume through a vapor permeable material. This material allows vapor to pass but blocks larger water droplets, dust, dirt, and light.

### GOVERNMENT INTEREST

The invention described herein may be manufactured, used, sold, imported, and/or licensed by or for the Government of the United States of America.

### FIELD OF THE INVENTION

This invention relates in general to optical devices, and more particularly, to an eyecup for interfacing a user's eyes to optical devices.

### BACKGROUND OF THE INVENTION

Optical devices include night vision goggles, camera view finders, microscopes, binoculars, and sighting scopes on firearms. An accessory often used with these devices is an eyecup. The purpose of the eyecup is two-fold. It can be used either to shield the eyepiece of the optical device from external light and stray light entering the optical path of the optical device, or to prevent light from leaking out of the optical device.

Night vision goggles are commonly used by the military for conducting operations in low light or night conditions. Eyecups prevent light from escaping from the night vision goggles and illuminating the user's face, thereby creating a risk of detection.

Examples of eyecups for night vision goggles are disclosed in U.S. Pat. No. 5,225,932 to Wannagot et al. and U.S. Pat. No. 4,698,857 to Kastendieck et al. These eyecups are primarily molded from pliable rubber. A ring made from semi-rigid plastic is often used as an insert to aid the attachment of the eyecup to the eyepiece of the optical device. The teachings of U.S. Pat. No. 4,698,857 to Kastendieck et al. and U.S. Pat. No. 5,225,932 to Wannagut et al. and the disclosures of which are hereby incorporated by reference.

The primary material used in eyecups is typically silicon rubber. This material is inexpensive and the manufacturing process is cost-effective. The silicon rubber remains pliable over wide temperature ranges, is resistant to mold, fungus, and bacteria and is not reactive with skin. However, a negative characteristic of rubber is its closed cell nature. It does not breathe nor allow water to permeate through it.

Moisture in the form of sweat evaporated from the skin of the optical device user builds up in the eyecup volume. Without a sufficiently-sized vent for the moisture to escape, fog forms on the surface of the eyepiece making it difficult to see. Creating a large vent or series of vents in the form of open holes in the eyecup wall would defeat the main purpose of the eyecup, which is to block or contain light. U.S. Pat. No. 4,698,857 to Kastendieck et al. discloses small air vent holes provided within the accordion section of the eyecup to prevent the occurrence of suction within the eyecup. The holes are approximately 0.125″ in diameter. The holes are purposely made small to minimize the escape of light and are positioned such that they are directed toward the user's nose. The holes in the Kastendieck device are not of sufficient size that enough moisture can escape to reduce fogging of the eyepiece. Attempts to create light-tight vents include the use of baffles and folds around the perimeter of the eyecup. Molding baffles into the eyecup increases the complexity and cost during manufacturing. In addition, these baffles create collection points for water, dust, and dirt during usage. A useful feature of the side-winged eyecup disclosed in U.S. Pat. No. 4,698,857 is its ability to fold backward, exposing the optical eyepiece. This folding feature enables the operator to move the eyecup out of the way without having to remove it. The addition of baffles would prohibit this feature.

### SUMMARY OF THE INVENTION

It is therefore an object of this invention to reduce the amount of fogging occurring on the eyepieces of night vision goggles and other optical devices from the build-up of moisture in the eyecup volume.

This and other objects of the invention are achieved in one aspect by an improvement in an eyecup for use with an optical device having an eyepiece for viewing an image. The eyecup is adapted to be fastened to the optical device and disposed between the user's eye and the eyepiece to prevent leakage of light from the eyepiece. The eyecup has a side wing section which extends backwardly toward the user's temple in order to conform to the contours of the user's head. The improvement is that the side wing section has an air vent in its wall of sufficient size that enough moisture in the form of sweat evaporated from the user's skin and trapped in the eyecup volume bounded by the eyepiece, the eyecup, and the user's eye, can escape through a light-blocking or -limiting vapor-permeable material covering the air vent to reduce fogging of the eyepiece.

Another aspect of the invention involves a method of using an eyecup with an optical device having an eyepiece for viewing an image. The eyecup is adapted to be fastened to the optical device and is disposed between the user's eye and the eyepiece to prevent leakage of light from the eyepiece. The eyecup has a side wing section which extends backwardly toward the user's temple in order to conform to the contours of the user's head. The improvement comprises a raised feature surrounding a light-blocking or -limiting vapor-permeable material covering an air vent in the side wing section's wall, a sufficient amount of moisture, in the form of sweat evaporated from the user's skin and trapped in the eyecup volume bounded by the eyepiece, the eyecup, and the user's eye, to reduce fogging of the eyepiece.

The vapor-permeable material allows water vapor to exit from the eyecup volume but not light and larger water droplets, dust, dirt, and light to enter.

The invention is compatible with current eyecup designs and construction methods. It will not prohibit the eyecup's performance over the wide temperature and environmental ranges required by the optical device. It is inexpensive to implement, and does not add significant weight or complexity to the existing eyecup designs.

Additional advantages and features will become apparent as the present invention becomes better understood by reference to the following detailed description when considered in conjunction with the accompanying drawings.

### BRIEF DESCRIPTION OF THE DRAWINGS

FIG. 1 shows night vision goggles with two eyecups attached to the eyepieces of the device.

FIG. 2 shows the eyecups detached from the night vision goggles.

FIG. 3A and FIG. 3B show two views of the eyecup.

FIG. 4A, FIG. 4B, and FIG. 4C show three additional views of the eyecup.

FIG. 5A and FIG. 5B show an embodiment of the raised feature in the eyecup.

### DETAILED DESCRIPTION

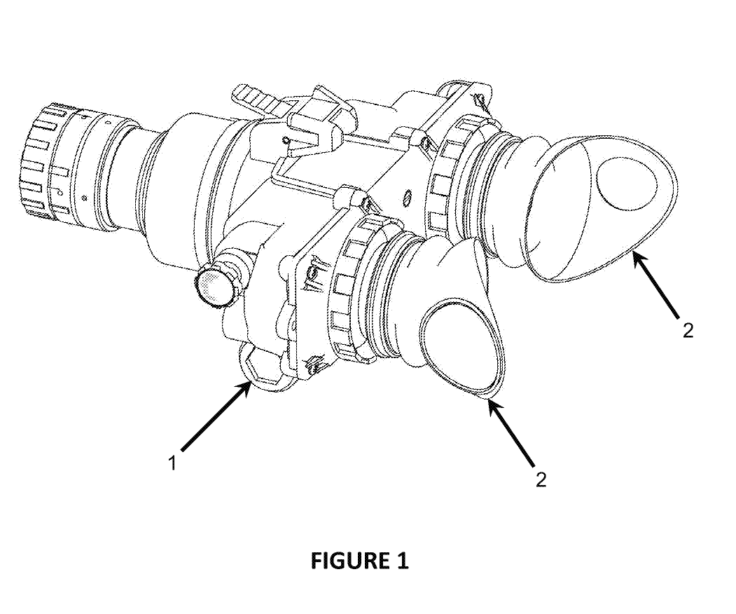

Referring to the drawings, wherein like reference numerals designate like or corresponding parts, and more particularly to FIG. 1, there is shown night vision goggles 1 with eyecups 2 of the present invention.

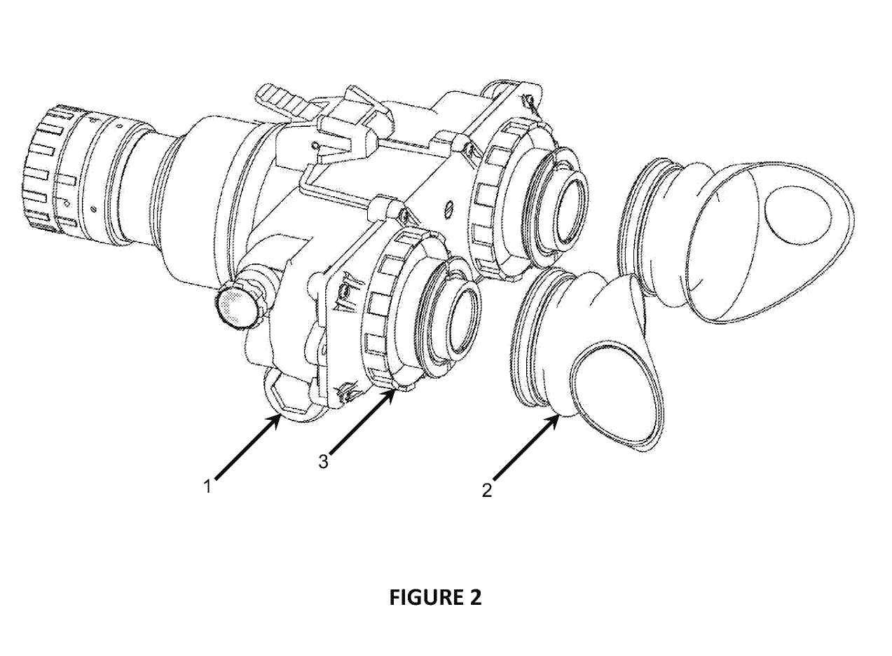

FIG. 2 shows night vision goggles 1 and detached eyecups 2. Eyecups 2 are adapted to be fastened to the night vision goggles 1 and disposed between an eyepiece 3 and a user's eye to prevent light escaping from the night vision goggles and illuminating the user's face, thereby creating a risk of detection.

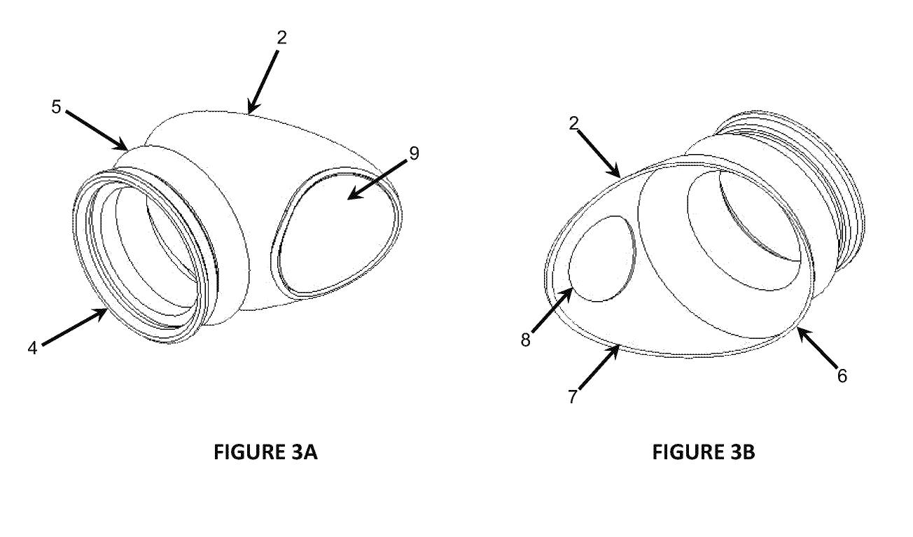

Referring to FIGS. 3A and 3B, eyecup 2 has three sections: an attaching end 4 for attaching the eyecup to an eyepiece of the night vision goggles, an intermediate flexible accordion section 5 which compensates for slight movement of the night vision goggles relative to the user's eyes, and a viewing end 6 which is specially curved to provide a sealing fit around the user's eye socket. The viewing end 6 has a side wing section 7 which extends backwardly toward the user's temple in order to conform to the contours of the user's head and air vent 8 in the eyecup covered by vapor-permeable material 9. Typically, the eyecup is constructed of a soft, conforming rubber material to provide a comfortable fit to variously dimensioned faces. This single material construction eases manufacturing and meets the required performance specifications. The light-blocking or -limiting vapor-permeable material 9 covering the air vent 8 is made of a different material from the remaining eyecup. One example of a light-blocking or -limiting vapor-permeable material is polytetrafluoro-ethylene (ePTFE) produced by W.L. Gore & Associates, Elkton, Md. The motivation for the bonding or joining of two or more dissimilar materials is to optimize the material properties for the assembly while maintaining low production costs. Another embodiment of the invention is to eliminate the covered vent hole and fabricate the entire eyecup with a light-blocking or -limiting vapor-permeable material which is soft, conformal, and meets the required performance specifications.

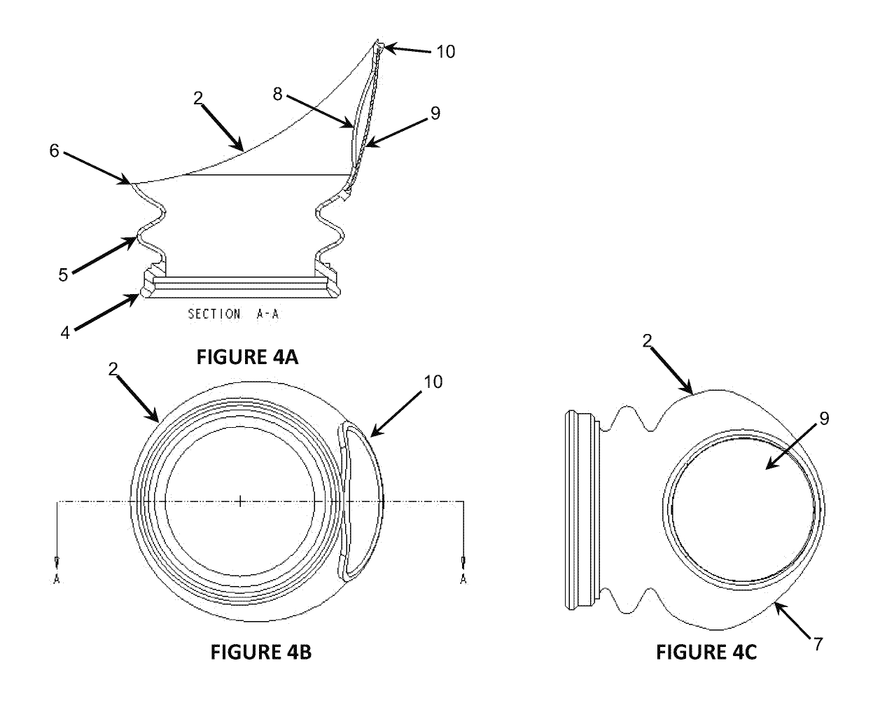

FIGS. 4A, 4B and 4C contain a different view of eyecup 2 with attaching end 4, accordion section 5, viewing end 6, side wing section 7, air vent 8 covered by a vapor permeable material 9 and surrounded by a raised feature 10.

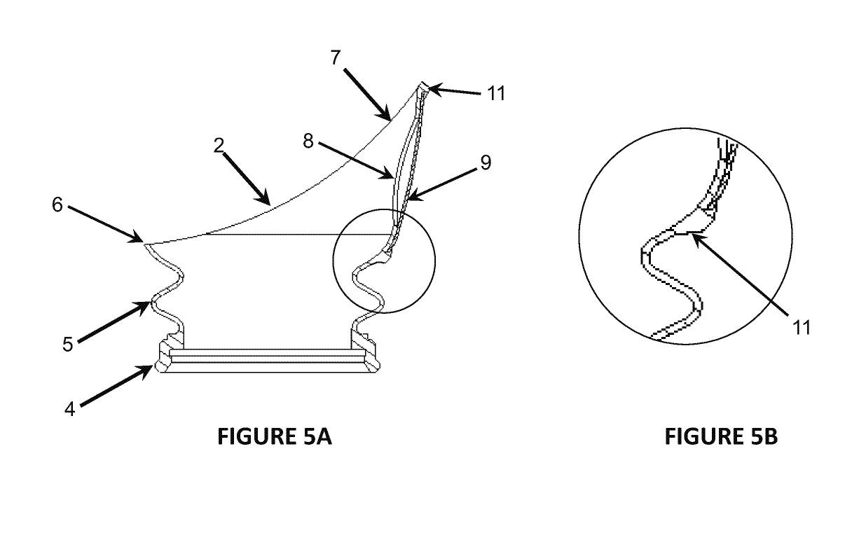

FIG. 5A contains an alternative embodiment of the raised feature 10 shown in FIG. 4A. FIG. 5A illustrates the eyecup 2 with attaching end 4, accordion section 5, viewing end 6, side wing section 7, air vent 8 covered by a vapor permeable material 9 and surrounded by a feature of greater wall thickness 11 than the other areas of the side wing section. FIG. 5B is a detailed view of FIG. 5A. This embodiment is different from the raised feature 10 in FIG. 4A because it blends the profile and avoids sharp corners and edges. This will facilitate the manufacturing of the eyecup.

In accordance with the invention, there is provided an air vent 8 in the wall of the side wing section 7, and a light-blocking or -limiting vapor-permeable material 9 covering the air vent 8. The air vent 8 is of sufficient size and shape that enough moisture in the form of sweat evaporated from the user's skin and trapped in the eyecup volume bounded by the eyepiece, the eyecup, and the user's eye, can escape through the light-blocking or -limiting vapor-permeable material to reduce fogging of the eyepiece.

The air vent can take any shape and can be patterned axially along or radially about the eyecup's axis. As shown in FIGS. 3B and 4A, the vent can be a hole of around 1 inch in diameter or a cut or a series of holes along or about the axis of the annulus.

The light-blocking or -limiting vapor-permeable material may be, for example, expanded polytetrafluoro-ethylene (ePTFE) membrane. The vapor-permeable material's tight weave allows for the passage of water vapor and gas molecules out of the eyecup volume while blocking the transmittance of light. The material also blocks the entrance of larger water droplets, dust, and dirt into the eyecup volume. The material also has hydrophobic and oleophobic characteristics to reduce the attraction of water and oil into the vent.

The incorporation of the vapor-permeable material to the rubber eyecup can be achieved in a number of ways. It can be molded-in during the molding of the eyecup's main structure, joined using adhesives, mechanical fasteners, thermal or sonic welding, or the like. It is the objective of this invention to maximize the surface area of the light-blocking or -limiting vapor-permeable material to the extent that the entire eyecup is vapor-permeable.

Due to the high physical handling rate of the eyecups, the vapor-permeable material must be resistant to tearing and separating from the rubber host material. To protect the edges of the vapor-permeable material 9 from separating from the rubber, a raised feature 10 or blended profile 11 around the air vent 8 is molded into the rubber structure. The edges of the vapor-permeable material should sit flush with or below the surrounding edges.

It is obvious that many modifications and variations of the present invention are possible in light of the above teachings. It is therefore to be understood that within the scope of the appended claims, the invention may be practiced otherwise than as described.

1. In an eyecup for use with an optical device having an eyepiece for viewing an image, the eyecup adapted to be fastened to the optical device and disposed between the user's eye and the eyepiece to prevent leakage of light from the eyepiece, the eyecup having a side wing section which extends backwardly toward the user's temple in order to conform to the contours of the user's head,
the improvement wherein the side wing section has an air vent in its wall, a light-blocking vapor-permeable material covers the air vent, and the air vent is of sufficient size and shape that enough moisture in the form of sweat evaporated from the user's skin and trapped in the eyecup volume bounded by the eyepiece, the eyecup, and the user's eye, can escape through the light-blocking vapor-permeable material to reduce fogging of the eyepiece.

2. The eyecup recited in claim 1 wherein the vapor permeable material is expanded polytetrafluoro-ethylene (ePTFE) membrane.

3. The eyecup recited in claim 1 wherein the eyecup is manufactured from rubber.

4. The eyecup recited in claim 1 wherein the eyecup is manufactured from polytetrafluoro-ethylene (ePTFE).

5. The air vent recited in claim 1 wherein the vent is a hole of approximately 1 inch in diameter.

6. The air vent recited in claim 1 wherein the vent is a series of holes.

7. The eyecup recited in claim 3 wherein the vent has a raised feature molded around it into the rubber structure to protect the edges of the permeable material from separating from the rubber.

8. The eyecup recited in claim 7 wherein the raised feature surrounding the vapor-permeable material is of a greater wall thickness than other areas of the side wing section.

9. The eyecup recited in claim 7 wherein the edges of the vapor permeable material sit flush with the surrounding edges.

10. The eyecup recited in claim 7 wherein the edges of the vapor permeable material sit below the surrounding edges.

11. An eyecup for use with an optical device having
an eyepiece for viewing an image, wherein the eyecup manufactured of a light-blocking vapor-permeable material is adapted to be fastened to the optical device and disposed between the user's eye and the eyepiece to prevent leakage of light from the eyepiece and
a side wing section of a light-blocking vapor-permeable material extending backwardly toward the user's temple in order to conform to the contours of the user's head to permit enough moisture evaporated from the user's skin and trapped in the eyecup volume bounded by the eyepiece, the eyecup, and the user's eye, to escape through the light-blocking vapor-permeable material to reduce fogging of the eyepiece.

12. The eyecup recited in claim 11 wherein the vapor-permeable material of the eyecup and the side wing section is manufactured from polytetrafluoro-ethylene (ePTFE).

13. In a method of using an eyecup with an optical device having an eyepiece for viewing an image, the eyecup adapted to be fastened to the optical device and disposed between the user's eye and the eyepiece to prevent leakage of light from the eyepiece, the eyecup having a side wing section which extends backwardly toward the user's temple in order to conform to the contours of the user's head, the improvement which comprises the step of:
venting, through a light-blocking vapor-permeable material covering an air vent in the side wing section's wall, a sufficient amount of moisture, in the form of sweat evaporated from the user's skin and trapped in the eyecup volume bounded by the eyepiece, the eyecup, and the user's eye, to reduce fogging of the eyepiece.

14. The method recited in claim 13 wherein the vapor permeable material is expanded polytetrafluoro-ethylene (ePTFE) membrane.

15. The method recited in claim 13 wherein the vapor-permeable material is incorporated to the rubber eyecup by being molded-in during the molding of the eyecup's main structure.

16. The method recited in claim 13 wherein the vapor-permeable material is incorporated to the rubber eyecup by being joined using thermal welding.

17. The method recited in claim 13 wherein the vapor-permeable material is incorporated to the rubber eyecup by being joined using sonic welding.

18. The method recited in claim 13 wherein a raised feature around the vent is molded into the rubber structure to protect the edges of the permeable material from separating from the rubber.
